(19) United States
(12) Patent Application Publication
(10) Pub. No.: US 2014/0130761 A1
(43) Pub. Date: May 15, 2014

(54) LASER SPARK PLUG AND OPERATING METHOD FOR SAME

(71) Applicants: Pascal Woerner, Korntal-Muenchingen (DE); Juergen Raimann, Weil Der Stadt (DE); Martin Weinrotter, Vitoria-Gasteiz (ES)

(72) Inventors: Pascal Woerner, Korntal-Muenchingen (DE); Juergen Raimann, Weil Der Stadt (DE); Martin Weinrotter, Vitoria-Gasteiz (ES)

(21) Appl. No.: 14/115,936

(22) PCT Filed: Mar. 5, 2012
(86) PCT No.: PCT/EP2012/053729

§ 371 Date: Jan. 29, 2014

(30) Foreign Application Priority Data
May 6, 2011 (EP) 10 2011 075 385.0

(51) Int. Cl. F02P 23/04

(52) U.S. Cl. CPC F02P 23/04
USPC 123/143 B; 701/102

(57) ABSTRACT

A laser spark plug, in particular for an internal combustion engine, includes a prechamber for accommodating an ignitable medium and means for applying laser radiation to an ignition point situated in the prechamber. The means are fashioned such that the laser radiation is focused onto at least one ignition point that, given a division of the prechamber into three partial regions that are approximately equal in volume and that extend axially away from an end face of the laser spark plug adjoining the prechamber and are separated from one another by imaginary planes situated essentially parallel to the end face, is situated in the partial region adjoining the end face or in a central partial region adjacent to said partial region, preferably in the partial region adjoining the end face.

### CROSS REFERENCE TO RELATED APPLICATION

The present application is the national stage entry of International Patent Application No. PCT/EP2012/053729, filed on Mar. 5, 2012, which claims priority to Application No. DE 10 2011 075 385.0, filed in the Federal Republic of Germany on May 6, 2011.

### FIELD OF INVENTION

The present invention relates to a laser spark plug, in particular for an internal combustion engine, having a prechamber for accommodating an ignitable medium and having means for applying laser radiation to an ignition point situated in the prechamber. The present invention also relates to a corresponding operating method.

### BACKGROUND INFORMATION

Laser spark plugs of the type named above are used for example in internal combustion engines of motor vehicles, or in particular also in stationary gas engines, in order to ignite an ignitable air/fuel mixture situated in a combustion chamber.

U.S. Pat. No. 7,770,552 describes a laser spark plug having a prechamber.

### SUMMARY

An object of the present invention is to improve a laser spark plug and an operating method of the type named above in order to make possible an optimally complete burning of the ignitable mixture present in the prechamber, and thus to enable the production of maximally energy-rich ignition torches that exit from the prechamber into a main combustion chamber.

In a laser spark plug of the type named above, this object is achieved according to the present invention in that the means for applying laser radiation to the ignition point are fashioned such that the laser radiation is focused onto at least one ignition point that, given a division of the prechamber into three partial regions approximately equal in volume and that extend axially away from an end face of the laser spark plug adjoining the prechamber and are separated from one another by imaginary planes situated essentially parallel to the end face, is situated in the partial region adjoining the end face or in a central partial region adjacent to said partial region, preferably in the partial region adjoining the end face.

According to investigations carried out by applicant, given such a positioning of the ignition point in the prechamber there results a particularly good and fast complete burning of the ignitable mixture situated in the prechamber, whereby particularly energy-rich igniting torches are obtained for the ignition of a mixture present in a main combustion chamber.

In a particularly preferred exemplary embodiment of the present invention, it is provided that a distance of the ignition point from the end face of the laser spark plug is between approximately 0 mm and approximately 15 mm, preferably between approximately 0 mm and approximately 10 mm. For example, the means for applying laser radiation to the ignition point can contain a focusing optics that, through a suitable design with regard for example to the focal width, can be configured such that the distance, according to the present invention, of the ignition point from the end face of the laser spark plug is obtained.

In a further advantageous exemplary embodiment, it is provided that the distance is between approximately 0 mm and approximately 5 mm, preferably between approximately 1 mm and approximately 3 mm.

According to trials carried out by applicant, the dimensioning according to the present invention of the distance of the ignition point from the end face of the laser spark plug has yielded a particularly efficient complete burning of the ignitable mixture contained in the prechamber, both in rinsed prechambers and in unrinsed prechambers, having different geometries in each case.

According to a further advantageous exemplary embodiment, a volume of the prechamber is approximately 50 mm³ to approximately 100 cm³, preferably approximately 500 mm³ to approximately 10 cm³.

According to a further advantageous exemplary embodiment, a wall segment limiting the prechamber has at least one crossflow channel that enables a fluid connection to a combustion chamber of the internal combustion engine. In this way, the prechamber of the laser spark plug according to the present invention can advantageously be charged with an ignitable mixture that flows from the main combustion chamber through the crossflow channels into the prechamber, for example during a compression stroke of the internal combustion engine.

According to a further exemplary embodiment, at least one crossflow channel can particularly advantageously be fashioned as a swirl channel in order to impress a tangential movement component, relative to a longitudinal axis of the crossflow channel, onto a fluid flowing through, with the result that the flow properties in the prechamber are still more controllable, in particular with regard to an optimal complete burning.

In a further advantageous exemplary embodiment, it is provided that at least one crossflow channel is fashioned as a tangential bore, and that at least one further crossflow channel is fashioned as a center hole that is situated approximately in the region of a longitudinal axis of the prechamber; according to investigations carried out by applicant, this results in a particularly advantageous mixing of remaining gas contained in the prechamber with fresh gas flowing from the main combustion chamber into the prechamber, in particular in the region of the longitudinal axis of the laser spark plug. In this way, it is ensured that an ignitable mixture is present in particular also at the location of the ignition point defined according to the present invention, and that the mixture there does not exceed a maximum allowable flow speed for a reliable laser ignition.

In a further advantageous exemplary embodiment, it is provided that the means for applying laser radiation to the ignition point situated in the prechamber and the crossflow channels are matched to one another such that in an operating state of the laser spark plug in which fluid flows into the prechamber via the at least one crossflow channel, the ignition point is situated in a region in which an average flow speed of the fluid is lower by at least approximately 30%, preferably approximately 50%, than in a region in which the crossflow channels are situated, thus advantageously ensuring that a fluid flow in the region of the ignition point does not become so large that it impairs an effective ignition of the mixture situated in the prechamber by the laser radiation.

As a further solution of the object of the present invention, an operating method is described. Further advantageous exemplary embodiments of the present invention are described herein.

Although, in particular given an application in the area of stationary engines or large gas engines, etc., the prechamber of the spark plug according to the present invention is preferably an integral component of the spark plug, or is formed by the spark plug itself, in a further exemplary variant of the present invention it can also be provided that a wall segment that limits the prechamber, in particular at the combustion chamber side, is formed at least partly by the cylinder head and/or is an integral component of the cylinder head. That is, in this case partial regions of the cylinder head and of the spark plug work together in a suitable manner in order to form the prechamber of the spark plug according to the present invention.

The prechamber can also be fashioned as a separate component. In this case, the prechamber can for example be connected to the spark plug by a screw connection, or can also be connected to the spark plug in non-detachable fashion. The prechamber can also have a screw connection for connection to a cylinder head.

It is also conceivable to realize the prechamber in one piece with the spark plug, or with a housing of the spark plug.

Further features, possible applications, advantages and exemplary embodiments of the present invention are described in the following with reference to the accompanying drawings. Here, all described or presented features, in themselves or in arbitrary combination, form the subject matter of the present invention, independent of their formulation or presentation in the description or in the drawings.

### BRIEF DESCRIPTION OF THE DRAWINGS

FIG. 1 shows a first exemplary embodiment of a laser spark plug according to the present invention, in a partial cross-section.

FIG. 2a shows an enlarged representation of an end region, having a prechamber, of a laser spark plug according to a further exemplary embodiment.

FIG. 2b shows the laser spark plug according to FIG. 2a with a fluid flow, indicated by block arrows, during an operating state of the laser spark plug.

FIG. 3 shows a further exemplary embodiment of a laser spark plug.

### DETAILED DESCRIPTION

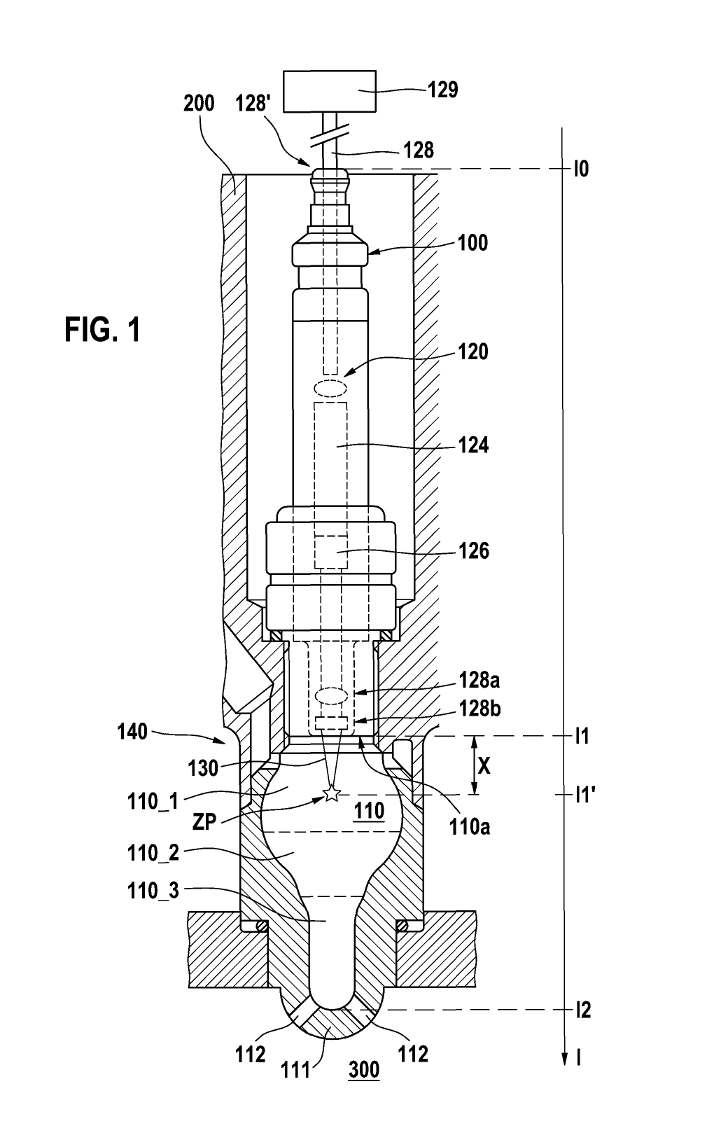

FIG. 1 shows a first exemplary embodiment of laser spark plug 100 according to the present invention in the installed position in a spark plug shaft of a cylinder head 200 of an internal combustion engine, which can for example be a stationary large gas engine.

Laser spark plug 100 has a prechamber 110 that can be charged with an ignitable mixture via an inlet valve 140. In the present case, laser spark plug 100 is accordingly equipped with a so-called “rinsed prechamber” 110. However, the present invention can also be applied to laser spark plugs having unrinsed prechambers, without limitation of generality. In order to ignite the ignitable mixture in prechamber 110, laser spark plug 100 has means 120 for applying laser radiation 130 to an ignition point ZP situated in prechamber 110. Preferably, means 120 can have for example a laser device that is in the present case fashioned monolithically, and a laser-active solid body 124 having a passive Q-switching 126.

Via a terminal 128′, spark plug 100 is connected to a light conductor device 128 that supplies the laser device integrated into spark plug 100 with pumped light from a remotely situated pumped light source 129. When laser-active solid body 124, or passive Q-switching 126, is supplied with pumped light from pumped light source 129, then in a known manner a laser impulse 130 is produced that is coupled into prechamber 110 from laser device 120 via a coupling optics 128a, 128b. The coupling optics preferably includes a focusing optics 128a for focusing laser radiation 130 onto ignition point ZP. In addition, the coupling optics has a combustion chamber window 128b that seals laser device 120 of spark plug 100 at its end toward prechamber 110.

Alternatively to the local production of laser ignition impulses 130 in laser spark plug 100, laser spark plug 100 could also be supplied with a laser ignition impulse via a light conductor device 128. In this case, laser spark plug 100 acts essentially for the radiation of laser ignition impulse 130 onto ignition point ZP, and if necessary for beam formation, without however requiring local production of laser radiation.

According to the present invention, it is provided that means 120, in the present case in particular components 128a, 128b of the coupling optics, are fashioned such that laser radiation 130 is focused onto at least one ignition point ZP that, given a division of prechamber 110 into three partial regions 110_1, 110_2, 110_3 that are approximately equal in volume and that extend axially away from an end face 110a of laser spark plug 100 adjoining prechamber 110 and are separated from one another by imaginary planes situated essentially parallel to end face 110a, is situated in partial region 110_1 adjoining end face 110a or in a central partial region 110_2 adjacent to said partial region, preferably in partial region 110_1 adjoining end face 110a.

According to investigations carried out by applicant, this results in a particularly efficient complete burning of the ignitable mixture situated in prechamber 110.

Particularly preferably, means 120 for applying laser radiation 130 to ignition point ZP are designed such that ignition point ZP is situated in first volume region 110_1, which directly adjoins end 110a of laser spark plug 100.

As can be seen in FIG. 1, end region 110a of laser spark plug 100 simultaneously forms a spatial limitation, acting upward in the axial direction in FIG. 1, of prechamber 110.

Particular preferably, distance X of ignition point ZP from end face 110a of laser spark plug 100 is between approximately 0 mm and approximately 15 mm, preferably between approximately 0 mm and approximately 10 mm.

Distance X can also further preferably be between approximately 0 mm and approximately 5 mm, in particular also between approximately 1 mm and approximately 3 mm.

In FIG. 1, in order to illustrate distance X a length coordinate I is plotted that in FIG. 1 extends vertically from the top to the bottom. An end region, facing away from the combustion chamber, of laser spark plug 100 corresponds to length coordinate I0. The end region facing the combustion chamber, i.e., in the present case also facing prechamber 110, of laser spark plug 100 corresponds with a length coordinate I1 that is simultaneously used as a reference for the definition of distance X according to the present invention. Length coordinate I1 agrees with end 110a of laser spark plug 100.

In FIG. 1, the volume of prechamber 110 thus extends from length coordinate I1 up to length coordinate I2.

The design according to the present invention of means 120 for producing or radiating laser radiation 130 into prechamber 110 ensures that ignition point ZP is situated inside first volume region 110_1, or at a maximum is situated inside second volume region 110_2. In the present case, the position of ignition point ZP results at a length coordinate I1′ for which the following holds: I1′−I1=X.

Advantageously, distance X according to the present invention is measured from an end region facing the combustion chamber or the prechamber, or from the corresponding end face 110a of laser spark plug 100. In the present case, end region 110a is formed by an end face of a housing of laser spark plug 100, and not for example by combustion chamber window 128b, which terminates the internal space of laser spark plug 100 toward prechamber 110, because, as seen in FIG. 1, combustion chamber window 128b is axially displaced slightly inward, i.e., upward in FIG. 1, in the axial direction relative to end face region 110a.

In the present case, prechamber 110 has a plurality of crossflow channels 112 in prechamber wall 111 that provide a fluid exchange with a main combustion chamber 300, situated at the external side of prechamber 110, of the internal combustion engine containing laser spark plug 100.

In a particularly preferred exemplary embodiment, it is provided that a volume of prechamber 110 is approximately 50 mm³ to approximately 100 cm³, preferably approximately 500 mm³ to approximately 10 cm³.

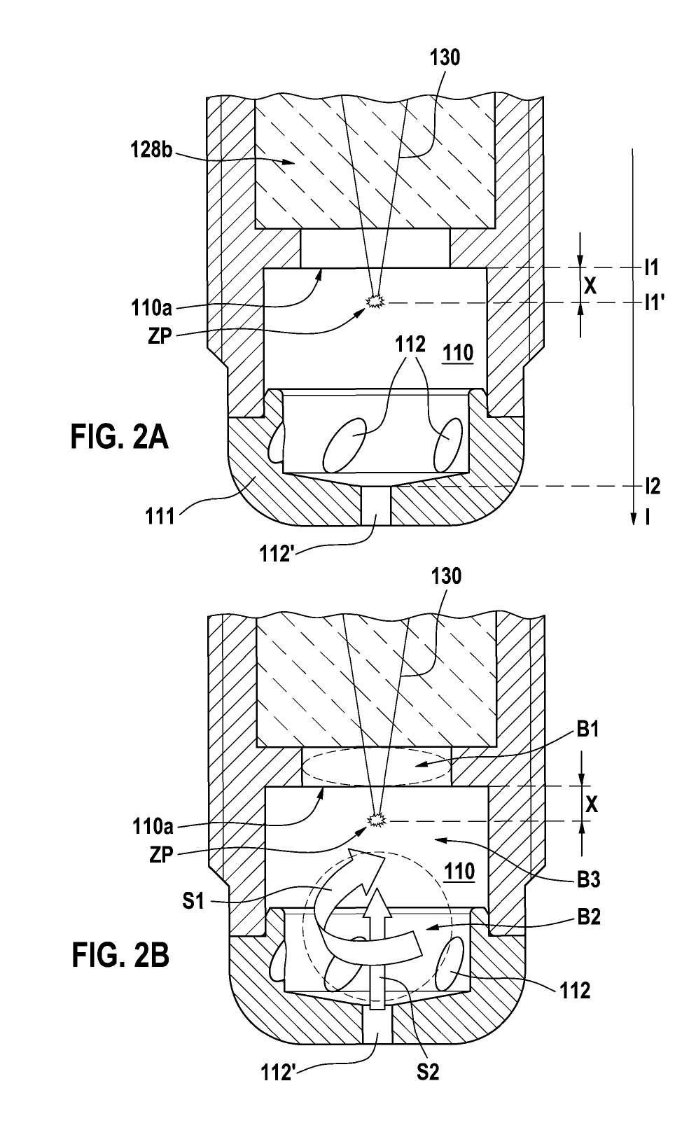

FIG. 2a shows an enlarged representation of an end region, having a prechamber, of a laser spark plug according to a further exemplary embodiment.

In FIG. 2a, prechamber 110 again extends in the vertical direction from length coordinate I1 up to length coordinate I2. For length coordinates I<I1, in the present case an opening connected directly to prechamber 110 is indeed also provided, but is used to accommodate a remaining gas cushion or for the shielding of the combustion chamber window, and therefore does not count toward the prechamber volume and is not used in the definition of distance X according to the present invention. This means that in the present case the distance X according to the present invention is measured vertically downward, starting from length coordinate I1 in FIG. 2a.

Prechamber 110 according to FIG. 2a has in its end region facing the combustion chamber a plurality of crossflow channels 112 that enable the passage of fluid from main combustion chamber 300 (FIG. 1) into prechamber 110 and vice versa. In the present case, crossflow channels 112 are oriented with regard to their longitudinal axes such that when fluid flows from main combustion chamber 300 into prechamber 110, there results an at least partly tangential fluid flow in prechamber 110, so that a stable fluid turbulence can form about the longitudinal axis of prechamber 110 or of laser spark plug 100.

In addition, a further crossflow opening 112′ can also be provided that is essentially situated in the region of the longitudinal axis of laser spark plug 100. Through the configuration shown in FIG. 2a of crossflow channels 112, 112′ there results an optimized mixture of remaining gas present in prechamber 110 with fresh ignitable mixture, so that optimal ignition conditions are present at ignition point ZP in prechamber 110.

FIG. 2b shows laser spark plug 100 according to FIG. 2a together with fluid flows indicated by block arrows as they arise during an operational state of laser spark plug 100.

A first fluid flow S1, having at least one tangential component, of ignitable mixture flowing out of main combustion chamber 300 (FIG. 1) into prechamber 110 arises in the manner shown by corresponding block arrow S1 in FIG. 2b. In addition, there arises a further flow S2, which in FIG. 2b essentially runs upward in the vertical direction.

In a first region B1, which, according to the definition according to the present invention of distance X, is not already part of the geometry of prechamber 110, but rather still belongs to the end face region of laser spark plug 100, there is a remaining gas cushion that, in a known manner, can act to protect combustion chamber window 128b from combustion residue or dirt particles.

A second region B2 having a relatively large flow speed arises in particular in the region of fluid flow S1, S2.

A third volume region B3 of prechamber 110, situated between first region B1 and second region B2, has, according to investigations carried out by applicant, optimal conditions for a laser ignition by laser igniting impulses 130. For most spark plug and prechamber geometries, region B3, which is particularly advantageous for the laser ignition, is situated in the volume portion of the prechamber volume that is at the top or in the center in FIG. 2b; cf. reference characters 110_1, 110_2 in FIG. 1. Therefore, given a suitable design of crossflow channels 112, 112′, and taking into account the definition according to the present invention of the distance X, optimal conditions for the laser ignition can be ensured at ignition point ZP.

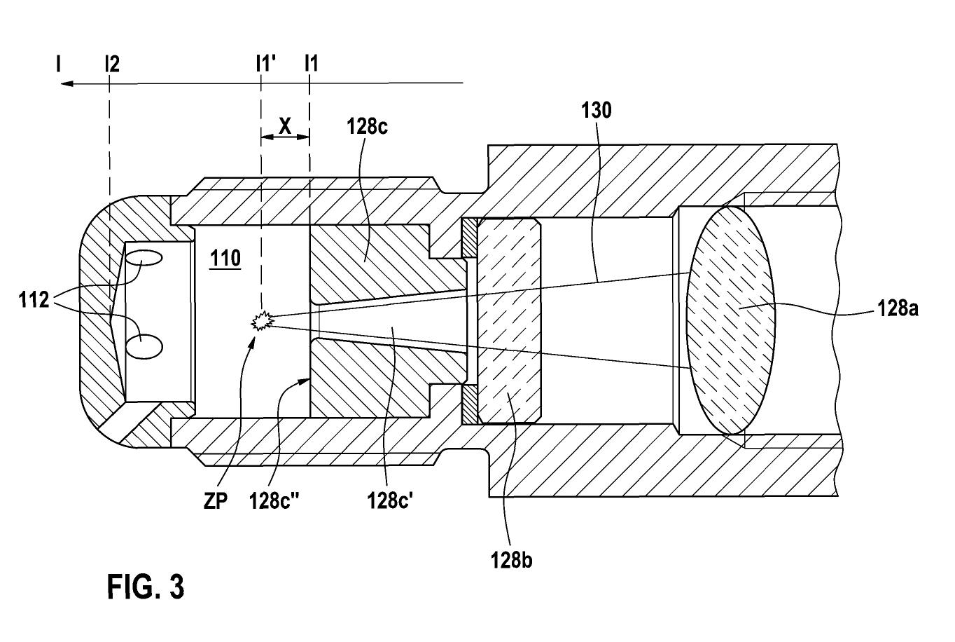

FIG. 3 shows, schematically and in partial cross-section, a further exemplary embodiment of a laser spark plug according to the present invention having a prechamber 110. Differing from the configuration according to FIG. 2a, laser spark plug 100 according to FIG. 3 has between combustion chamber window 128b and prechamber 110 a so-called light path module 128c that has an essentially cone-shaped opening 128c′ that enables laser radiation 130 from laser spark plug 100 to pass through into prechamber 110. At the same time, due to the geometry according to the present invention of light path module 128c there is a reduction of dirt particles from combustion processes moving from prechamber 110 into the region of an optically effective surface of combustion chamber window 128b.

In this exemplary variant of the present invention as well, laser radiation 130 is preferably radiated into prechamber 110 according to the dimensioning rule for distance X. Here it is again to be noted that distance X selected according to the present invention is measured from end region 128c″ of light path module 128c, because conical light guide opening 128c′ of light path module 128c does not already count towards the prechamber volume of prechamber 110.

According to a further advantageous exemplary embodiment, means 120 for applying laser radiation 130 to ignition point ZP situated in prechamber 110 and crossflow channels 112, 112′ are matched to one another such that in an operating state of laser spark plug 100 in which fluid flows into prechamber 110 via the at least one crossflow channel 112, 112′, ignition point ZP is situated in a region B3 (FIG. 2b) in which an average flow speed of the fluid or ignitable mixture is lower by at least approximately 30%, preferably approximately 50%, than in a region B2 in which crossflow channels 112, 112′ are situated.

1-11. (canceled)

12. A laser spark plug for an internal combustion engine, comprising:
a prechamber adapted for accommodating an ignitable medium; and
a device adapted for applying laser radiation to at least one ignition point situated in the prechamber,
wherein, given a division of the prechamber into three partial regions that are approximately equal in volume, that extend axially away from an end face of the laser spark plug adjoining the prechamber, and that are separated from one another by imaginary planes situated essentially parallel to the end face, the device is adapted such that the laser radiation is focused onto the at least one ignition point that is situated in a partial region adjoining the end face or in a central partial region adjacent to the partial region adjoining the end face.

13. The laser spark plug according to claim 12, wherein a distance of the ignition point from the end face of the laser spark plug is between approximately 0 mm and approximately 15 mm, or between approximately 0 mm and approximately 10 mm.

14. The laser spark plug according to claim 13, wherein the distance is between approximately 0 mm and approximately 5 mm, or between approximately 1 mm and approximately 3 mm.

15. The laser spark plug according to claim 12, wherein a volume of the prechamber is from approximately 50 mm³ to approximately 100 cm³, or from approximately 500 mm³ to approximately 10 cm³.

16. The laser spark plug according to claim 12, further comprising:
a wall segment that limits the prechamber and having at least one crossflow channel that enables a fluid connection to a combustion chamber of the internal combustion engine.

17. The laser spark plug according to claim 16, wherein the at least one crossflow channel is a swirl channel adapted to impress a tangential movement component, relative to a longitudinal axis of the crossflow channel, onto a fluid flowing through.

18. The laser spark plug according to claim 16, wherein the at least one crossflow channel is a tangential bore, and at least one further crossflow channel is a center hole situated approximately in a region of a longitudinal axis of the prechamber.

19. The laser spark plug according to claim 16, wherein the device adapted for applying laser radiation to the ignition point situated in the prechamber and the at least one crossflow channel are matched to one another such that, in an operating state of the laser spark plug in which fluid flows into the prechamber via the at least one crossflow channel, the ignition point is situated in a region in which an average flow speed of the fluid is lower by at least approximately 30%, or approximately 50%, than in a region in which the at least one crossflow channel is situated.

20. A method for operating a laser spark plug for an internal combustion engine, the laser spark plug including a prechamber adapted for accommodating an ignitable medium and a device adapted for applying laser radiation to at least one ignition point situated in the prechamber, the method comprising:
given a division of the prechamber into three partial regions that are approximately equal in volume, that extend axially away from an end face of the laser spark plug adjoining the prechamber, and that are separated from one another by imaginary planes situated essentially parallel to the end face, focusing, by the device, the laser radiation onto the at least one ignition point that is situated in a partial region adjoining the end face or in a central partial region adjacent to the partial region adjoining the end face.

21. The method according to claim 20, wherein the device focuses the laser radiation such that a distance of the ignition point from the end face of the laser spark plug is between approximately 0 mm and approximately 15 mm, or between approximately 0 mm and approximately 10 mm.

22. The method according to claim 21, wherein the device focuses the laser radiation such that the distance is between approximately 0 mm and approximately 5 mm, or between approximately 1 mm and approximately 3 mm.
